(19) United States
(12) Patent Application Publication
(10) Pub. No.: US 2010/0267600 A1
(43) Pub. Date: Oct. 21, 2010

(54) Surfactant Mixtures With Synergistic Characteristics

(75) Inventors: Frank Richter, Frankfurt am Main (DE); Nicole Nitschke, Eschborn (DE); Gerd Reinhardt, Kelkheim (DE)

Correspondence Address: CLARIANT CORPORATION;INTELLECTUAL PROPERTY DEPARTMENT, 4000 MONROE ROAD, CHARLOTTE, NC, 28205, US

(73) Assignee: CLARIANT FINANCE (BVI) LIMITED, Tortola (VG)

(21) Appl. No.: 12/665,011

(22) PCT Filed: Jun. 13, 2008
(86) PCT No.: PCT/EP2008/004744

§ 371 Date: Jun. 9, 2010

(30) Foreign Application Priority Data
Jun. 20, 2007 (DE) 10 2007 028 310.7

(51) Int. Cl. C11D 3/34

(52) U.S. Cl. 510/228

(57) ABSTRACT

The invention discloses mixtures consisting of two or three surfactants from the group containing secondary alkane sulfonates, α-methyl ester sulfonates and φ-methyl ester sulfonates. Said mixtures exhibit a synergistic cleaning action in comparison to the respective individual surfactants.

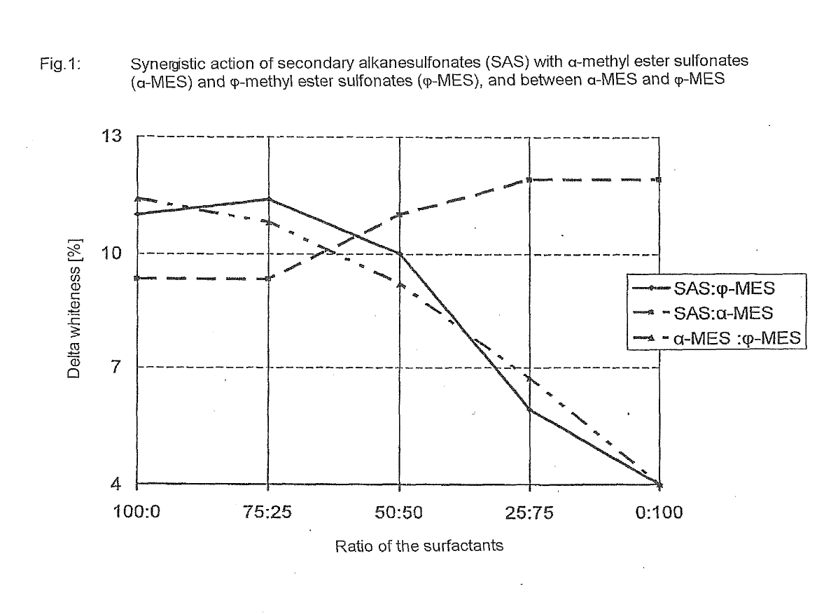

The invention relates to combinations of secondary alkanesulfonates (SAS), α-methyl ester sulfonates (α-MES) and φ-methyl ester sulfonates (φ-MES).

The use of SAS in washing product formulations is sufficiently well known; the use of α-methyl ester sulfonates in washing product formulations is described in WO 98/42813 and in U.S. Pat. No. 5,454,982. The synthesis of φ-methyl ester sulfonates and use thereof in washing products is described in ES 2 125 827. However, none of these documents describes mixtures of these surfactants.

Surprisingly, synergistic effects have now been found in combinations of these surfactants, which have an improved washing and cleaning performance compared to the individual surfactants.

The invention provides surfactant mixtures consisting of two or three surfactants from the group of secondary alkanesulfonates, α-methyl ester sulfonates and φ-methyl ester sulfonates. Preference is given to mixtures of two of the types of surfactants mentioned in each case, i.e. mixtures of SAS and α-MES, SAS and φ-MES or α-MES and φ-MES. The ratio of the two surfactants is generally between 99:1 and 1:99, but the preferred ratios depend on the particular surfactant and are described as follows:

### SAS: φ-MES 90:10 to 60:40

### SAS: α-MES 50:50 to 10:90

### α-MES: φ-MES 90:10 to 30:70

The three types of anionic surfactants mentioned are sufficiently well known. The sec-alkanesulfonates are compounds of the formula R—SO₃M where R is alkyl having approx. 10 to 20 carbon atoms and M is an alkali metal, alkaline earth metal or ammonium ion.

α-Methyl ester sulfonates are compounds of the formula R—CHSO₃M—COOCH₃ where R is a C₆-C₂₀-alkyl radical and M is an alkali metal, alkaline earth metal or ammonium cation. As is well known, the products are obtained by reaction of fatty acid methyl esters with sulfur trioxide. Suitable alpha-sulfonated methyl esters are those of hydrogenated coconut, palm kernel or tallow fatty acids, which are prepared by sulfonating the methyl esters of fatty acids of vegetable and/or animal origin having 8 to 20 carbon atoms in the fatty acid molecule and then neutralizing them to give water-soluble mono-salts.

φ-Methyl ester sulfonates are likewise sulfonation products of C₆-C₂₀-fatty acid methyl esters. In contrast to the α-methyl ester sulfonates, the φ-methyl ester sulfonates are obtained by photosulfoxidation, i.e. by irradiation of a mixture of fatty acid methyl ester, water, oxygen and SO₂ with UV light (see ES 2 125 827). This reaction affords products in which the sulfo group is not incorporated in the α position of the fatty acid residue, but is distributed randomly over the entire chain.

These mixtures of anionic surfactants can be used in customary liquid or solid washing and cleaning products, together with the constituents known and customary therefor, as described hereinafter.

Examples thereof are heavy-duty washing products, light-duty washing products, color washing products, wool washing products, curtain washing products, modular washing products, washing tablets, soap bars, stain removal salts and washing power enhancers.

The inventive surfactant combinations can also be incorporated especially into manual dishwashing detergents, domestic cleaning products, for example all-purpose cleaners, cleaning and care products for floors and other hard surfaces, for example made of plastic, ceramic or glass, or surfaces with nanotechnological coatings. The washing and cleaning product formulations in which the inventive mixtures can be used are in pulverulent, granule, paste, gel or liquid form. The inventive washing, care and cleaning product formulations comprise at least 1% by weight, preferably between 3 and 40% by weight and more preferably 4 to 30% by weight of the inventive surfactant combinations, based on the finished products.

The inventive washing and cleaning products may especially comprise further surfactants, peroxygen compounds, peroxygen activators or organic peracids, builders, inorganic and organic acids, bases, cleaning enhancers, solvents, hydrotropes, buffers, complexing agents, preservatives, thickeners, skin protection agents, foam regulators, active disinfectant ingredients, enzymes and specific additives with color or fiber-conserving action. Further assistants such as electrolytes, and dyes and fragrances, are possible.

An inventive cleaning product for hard surfaces may further comprise constituents with abrasive action, especially from the group comprising quartz flours, wood flours, polymer flours, chalk and glass microspheres, and mixtures thereof. Abrasives are present in the inventive cleaning products preferably at a level not more than 20% by weight, especially of 5 to 15% by weight.

The washing and cleaning products may, as well as the inventive surfactant combinations, comprise one or more further surfactants, useful surfactants being especially anionic surfactants, nonionic surfactants and mixtures thereof, but also cationic, zwitterionic and amphoteric surfactants. Such surfactants are present in inventive washing products in proportions of preferably 1 to 50% by weight, especially of 3 to 30% by weight, whereas smaller proportions, i.e. amounts up to 20% by weight, especially up to 10% by weight and preferably in the range from 0.5 to 5% by weight, are normally present in cleaning products for hard surfaces.

Anionic surfactants suitable in addition to the inventive surfactant combinations are especially soaps and those which contain sulfate or sulfonate groups. Useful surfactants of the sulfonate type are preferably C₈-C₁₈-alkylbenzenesulfonates, olefinsulfonates, i.e. mixtures of alkene- and hydroxyalkanesulfonates, and also disulfonates, as obtained, for example, from monoolefins having terminal or internal double bonds by sulfonation with gaseous sulfur trioxide and subsequent alkaline or acidic hydrolysis of the sulfonation products. Also suitable are alkanesulfonates which are obtained from C₁₂-C₁₈-alkanes, for example by sulfochlorination with subsequent hydrolysis or neutralization.

Further suitable anionic surfactants are sulfated fatty acid glycerol esters, which are mono-, di- and triesters, and mixtures thereof. Preferred alk(en)yl sulfates are the alkali metal and especially the sodium salts of the sulfuric monoesters of the C₁₂-C₁₈-fatty alcohols, for example of coconut fatty alcohol, tallow fatty alcohol, lauryl, myristyl, cetyl or stearyl alcohol, or of the C₈-C₂₀-oxo alcohols and those monoesters of secondary alcohols of this chain length. Also preferred are alk(en)yl sulfates of the chain length mentioned which contain a synthetic, straight-chain alkyl radical prepared on a petrochemical basis. Also suitable are the sulfuric monoesters of the straight-chain or branched alcohols ethoxylated with 1 to 6 mol of ethylene oxide, such as 2-methyl-branched C₉-C₁₁-alcohols with on average 3.5 mol of ethylene oxide (EO) or C₁₂-C₁₈ fatty alcohols with 1 to 4 EO.

The preferred anionic surfactants also include the salts of alkylsulfosuccinic acid, which are also referred to as sulfosuccinates or as sulfosuccinic esters, and the mono- and/or diesters of sulfosuccinic acid with alcohols, preferably with fatty alcohols and especially with ethoxylated fatty alcohols. Preferred sulfosuccinates contain C₈-C₁₈ fatty alcohol radicals or mixtures of these. Useful further anionic surfactants include fatty acid derivatives of amino acids, for example of N-methyltaurine (taurides) and/or of N-methylglycine (sarcosinates). Useful further anionic surfactants include especially soaps, for example in amounts of 0.2 to 5% by weight. Especially suitable are saturated fatty acid soaps, such as the salts of lauric acid, myristic acid, palmitic acid, stearic acid, hydrogenated erucic acid and behenic acid, and also especially soap mixtures derived from natural fatty acids, for example coconut, palm kernel or tallow fatty acids.

The anionic surfactants, including the soaps, which are present in addition to the inventive surfactant combinations, may be present in the form of their sodium, potassium or ammonium salts, and as soluble salts of organic bases, such as mono-, di- or triethanolamine. The anionic surfactants are preferably present in the form of their sodium or potassium salts, especially in the form of the sodium salts. Anionic surfactants are present in inventive washing products preferably in amounts of 0.5 to 50% by weight and especially in amounts of 5 to 25% by weight.

The nonionic surfactants used are preferably alkoxylated, advantageously ethoxylated, especially primary alcohols having preferably 8 to 18 carbon atoms and on average 1 to 12 mol of ethylene oxide (EO) per mole of alcohol, in which the alcohol radical may be linear or preferably 2-methyl-branched, or may contain linear and methyl-branched radicals in a mixture, as typically present in oxoalcohol radicals. However, especially preferred are alcohol ethoxylates having linear radicals from alcohols of native origin having 12 to 18 carbon atoms, for example from coconut, palm, tallow fat or oleyl alcohol, and on average 2 to 8 EO per mole of alcohol. The preferred ethoxylated alcohols include, for example, C₁₂-C₁₄-alcohols with 3 EO or 4 EO, C₉-C₁₁-alcohols with 7 EO, C₁₃-C₁₅-alcohols with 3 EO, 5 EO, 7 EO or 8 EO, C₁₂-C₁₈-alcohols with 3 EO, 5 EO or 7 EO and mixtures of these, such as mixtures of C₁₂-C₁₄-alcohol with 3 EO and C₁₂-C₁₈-alcohol with 7 EO. The degrees of ethoxylation specified constitute statistical averages which may be an integer or a fraction for a specific product. Preferred alcohol ethoxylates have a narrow homolog distribution (narrow range ethoxylates, NRE). In addition to these nonionic surfactants, fatty alcohols with more than 12 EO may also be used. Examples thereof are (tallow) fatty alcohols with 14 EO, 16 EO, 20 EO, 25 EO, 30 EO or 40 EO.

The nonionic surfactants also include alkylpolyglycosides of the general formula RO(G)ₓ in which R is a primary, straight-chain or methyl-branched, especially 2-methyl-branched, aliphatic radical having 8 to 22, preferably 12 to 18, carbon atoms, and G is a glycoside unit having 5 or 6 carbon atoms, preferably glucose. The degree of oligomerization x which specifies the distribution of monoglycosides and oligoglycosides is an arbitrary number, which may also assume fractional values as a quantity to be determined analytically, between 1 and 10; x is preferably 1.2 to 1.4. Likewise suitable are polyhydroxy fatty acid amides of the formula (I) in which the R¹CO radical is an aliphatic acyl radical having 6 to 22 carbon atoms, R² is hydrogen, an alkyl or hydroxyalkyl radical having 1 to 4 carbon atoms and [Z] is a linear or branched polyhydroxyalkyl radical having 3 to 10 carbon atoms and 3 to 10 hydroxyl groups.

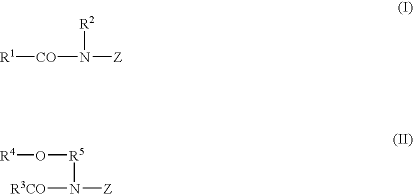

The polyhydroxy fatty acid amides preferably derive from reducing sugars having 5 or 6 carbon atoms, especially from glucose. The group of the polyhydroxy fatty acid amides also includes compounds of the formula (II) where R³ is a linear or branched alkyl or alkenyl radical having 7 to 12 carbon atoms, R⁴ is a linear, branched or cyclic alkylene radical or an arylene radical having 2 to 8 carbon atoms and R⁵ is a linear, branched or cyclic alkyl radical or an aryl radical, or an oxyalkyl radical having 1 to 8 carbon atoms, preference being given to C₁-C₄-alkyl or phenyl radicals, and [Z] is a linear polyhydroxyalkyl radical whose alkyl chain is substituted by at least two hydroxyl groups, or alkoxylated, preferably ethoxylated or propoxylated, derivatives of this radical. [Z] is obtained here too preferably by reductive amination of a sugar such as glucose, fructose, maltose, lactose, galactose, mannose or xylose. The N-alkoxy or N-aryloxy-substituted compounds may then be converted to the desired polyhydroxy fatty acid amides by reacting with fatty acid methyl esters in the presence of an alkoxide as a catalyst.

A further class of nonionic surfactants used with preference, which may be used either as the sole nonionic surfactant or in combination with other nonionic surfactants, especially together with alkoxylated fatty alcohols and/or alkylglycosides, is that of alkoxylated, preferably ethoxylated or ethoxylated and propoxylated, fatty acid alkyl esters, preferably having 1 to 4 carbon atoms in the alkyl chain, especially fatty acid methyl esters.

Nonionic surfactants of the amine oxide type, for example N-cocoalkyl-N,N-dimethylamine oxide and N-tallowalkyl-N,N-dihydroxyethylamine oxide and of the fatty acid alkanolamides may also be suitable.

Useful further surfactants are what are known as gemini surfactants. This generally refers to those compounds which have two hydrophilic groups per molecule. These groups are generally separated from one another by a “spacer”. This spacer is generally a carbon chain which should be long enough that the hydrophilic groups have a sufficient separation and they can act independently of one another. Such surfactants generally feature an unusually low critical micelle concentration and the ability to greatly reduce the surface tension of water. However, it is also possible to use gemini polyhydroxy fatty acid amides or polyhydroxy fatty acid amides. Further surfactant types may have dendrimeric structures.

Suitable peroxidic bleaches are hydrogen peroxide and compounds which release hydrogen peroxide under the washing and cleaning conditions, such as alkali metal peroxides, organic peroxides such as urea-hydrogen peroxide adducts, and inorganic persalts such as alkali metal perborates, percarbonates, perphosphates, persilicates, persulfates and peroxynitrites. Mixtures of two or more of these compounds are likewise suitable. Particular preference is given to sodium perborate tetrahydrate and especially sodium perborate monohydrate, and also sodium percarbonate. Sodium perborate monohydrate is preferred owing to its good storage stability and its good solubility in water. Sodium percarbonate may be preferred for ecological reasons.

Hydroperoxides are a further suitable group of peroxide compounds. Examples of these substances are cumene hydroperoxide and t-butyl hydroperoxide. Aliphatic or aromatic mono- or dipercarboxylic acids and the corresponding salts are also suitable as peroxy compounds. Examples thereof are peroxynaphthoic acid, peroxylauric acid, peroxystearic acid, N,N-phthaloylaminoperoxycaproic acid (PAP), 1,12-diperoxydodecanedioic acid, 1,9-diperoxyazelaic acid, diperoxysebacic acid, diperoxyisophthalic acid, 2-decyldiperoxybutane-1,4-dioic acid and 4,4′-sulfonylbisperoxybenzoic acid.

In the washing and cleaning products, it is also possible for suitable bleach activators to be present in the customary amounts (approx. 1 to 10% by weight).

Suitable bleach activators are organic compounds having an O-acyl or N-acyl group, especially from the group of the activated carboxylic esters, especially sodium nonanoyloxybenzenesulfonate, sodium isononanoyloxy-benzenesulfonate, sodium 4-benzoyloxybenzenesulfonate, sodium trimethylhexanoyloxybenzenesulfonate, carboxylic anhydrides, especially phthalic anhydride, acylated polyhydric alcohols, especially triacetin, ethylene glycol diacetate, 2,5-diacetoxy-2,5-dihydrofuran, lactones, acylals, carboxamides, acylated ureas and oxamides, N-acylated hydantoins, for example 1-phenyl-3-acetylhydantoin, hydrazides, triazoles, hydrotriazines, urazoles, diketopiperazides, sulfurylamides, polyacylated alkylenediamines, for example N,N,N′,N′-tetraacetylethylenediamine (TAED), acylated triazine derivatives, especially 1,5-diacetyl-2,4-dioxohexahydro-1,3,5-triazine, acylated glycolurils, especially tetraacetylglycoluril, N-acylimides, especially N-nonanoylsuccinimide, and acylated sugar derivatives, especially pentaacetylglucose (PAG), pentaacetylfructose, tetraacetylxylose and octaacetyllactose, and also acetylated, optionally N-alkylated glucamine and gluconolactone, and/or N-acylated lactams, for example N-benzoylcaprolactam, but also nitrile compounds, for example quaternary trialkylammonionitrile salts as described in EP-A-303 520, EP-A-458 396 and EP-A-464 880, especially the cyanomethyltrimethylammonium salt, but also heterocyclically substituted quaternary nitrile compounds as described in EP-A-790 244.

In addition to the conventional bleach activators listed above or in their stead, it is also possible to use sulfonimines, open-chain or cyclic quaternary iminium compounds such as dihydroisoquinolinium quats or dihydroisoquinolinium betaines and/or bleach-boosting transition metal salts or mono- or polynuclear transition metal complexes with acyclic or macrocyclic ligands.

Suitable organic and inorganic builders are neutral or especially alkaline salts which can precipitate or complex calcium ions. Suitable builder substances which are in particular ecologically uncontroversial are crystalline sheet-type silicates of the formula NaMSi(ₓ)O(₂ₓ₊₁) where M is sodium or hydrogen, x is 1.9 to 22, preferably 1.9 to 4, and y is 0 to 33, for example Na-SKS-5 (α-Na₂Si₂O₅), Na-SKS-7 (β-Na₂Si₂O₅, natrosilite), Na-SKS-9 (NaHSi₂O₅*H₂O), Na-SKS-10 (NaHSi₂O₃*3H₂O, kanemite), Na-SKS-11 (t-Na₂Si₂O₅) and Na-SKS-13 (NaHSi₂O₅), but especially Na-SKS-6 (δ-Na₂Si₂O₅), and also finely crystalline synthetic water-containing zeolites, especially of the NaA type, which have a calcium binding capacity in the range from 100 to 200 mg CaO/g.

Zeolites and sheet silicates may be present in an amount of up to 60% by weight in the product.

Additionally suitable are non-neutralized or partly neutralized (co)polymeric polycarboxylic acids. These include the homopolymers of acrylic acid or of methacrylic acid or copolymers thereof with further ethylenically unsaturated monomers, for example acroiein, dimethylacrylic acid, ethylacrylic acid, vinylacetic acid, allylacetic acid, maleic acid, fumaric acid, itaconic acid, meth(allylsulfonic acid), vinylsulfonic acid, styrenesulfonic acid, acrylamidomethylpropanesulfonic acid, and monomers containing phosphorus groups, for example vinylphosphoric acid, allylphosphoric acid and acrylamidonnethylpropanephosphoric acid and salts thereof, and also hydroxyethyl (meth)acrylate sulfate, allyl alcohol sulfate and allyl alcohol phosphates.

Preferred (co)polymers have a mean molar mass of 1000 to 100 000 g/mol, preferably of 2000 to 75 000 g/mol and especially of 2000 to 35 000 g/mol. The degree of neutralization of the acid groups is advantageously 0 to 90%, preferably 10 to 80% and especially 30 to 70%.

The suitable polymers include in particular also homopolymers of acrylic acid and copolymers of (meth)acrylic acid with maleic acid or maleic anhydride.

Further suitable copolymers derive from terpolymers which can be obtained by polymerizing 10 to 70% by weight of monoethylenically unsaturated dicarboxylic acids having 4 to 8 carbon atoms, salts thereof, 20 to 85% by weight of monoethylenically unsaturated monocarboxylic acids having 3 to 10 carbon atoms or salts thereof, 1 to 50% by weight of monounsaturated monomers which, after hydrolysis, release hydroxyl groups on the polymer chain, and 0 to 10% by weight of further free-radically copolymerizable monomers.

Likewise suitable are graft polymers of monosaccharides, oligosaccharides, polysaccharides and modified polysaccharides, and also animal or vegetable proteins.

Preference is given to copolymers of sugar and other polyhydroxyl compounds and a monomer mixture composed of 45 to 96% by weight of monoethylenically unsaturated C₃- to C₁₀-monocarboxylic acids or mixtures of C₃- to C₁₀-monocarboxylic acids and/or salts thereof with monovalent cations, 4 to 55% by weight of monomers containing monoethylenically unsaturated monosulfonic acid groups, monoethylenically unsaturated sulfuric esters, vinylphosphoric esters and/or the salts of these acids with monovalent cations, and 0 to 30% by weight of water-soluble unsaturated compounds which have been modified with 2 to 50 mol of alkylene oxide per mole of monoethylenically unsaturated compounds.

Further suitable polymers are polyaspartic acid and derivatives thereof in non-neutralized or only partly neutralized form.

Also particularly suitable are graft polymers of acrylic acid, methacrylic acid, maleic acid and further ethylenically unsaturated monomers onto salts of polyaspartic acid, as typically obtained in the above-described hydrolysis of the polysuccinimide. It is possible here to dispense with the otherwise necessary addition of acid for the preparation of the only partly neutralized form of the polyaspartic acid. The amount of polyaspartate is typically selected such that the degree of neutralization of all carboxyl groups incorporated in the polymer does not exceed 80%, preferably 60%.

Further usable builders are, for example, the carboxylic acids used preferably in the form of their sodium salts, such as citric acid, especially trisodium citrate and trisodium citrate dihydrate, nitrilotriacetic acid and its water-soluble salts; the alkali metal salts of carboxymethyloxysuccinic acid, ethylenediaminetetraacetic acid, mono-, dihydroxysuccinic acid, α-hydroxy-propionic acid, gluconic acid, mellitic acid, benzopolycarboxylic acids and those as disclosed in U.S. Pat. Nos. 4,144,226 and 4,146,495.

Also suitable are phosphate-containing builders, for example alkali metal phosphates, which may be present in the form of their alkaline, neutral or acidic sodium or potassium salts.

Examples thereof are trisodium phosphate, tetrasodium diphosphate, disodium dihydrogenphosphate, pentasodium triphosphate, so-called sodium hexametaphosphate, oligomeric trisodium phosphate with degrees of oligomerization in the range from 5 to 1000, especially 5 to 50, and mixtures of sodium and potassium salts.

These builder substances may be present from 5 to 80% by weight; preference is given to a proportion of 10 to 60% by weight.

It is likewise possible to use complexing agents, such as ethane-1-hydroxy-1,1-diphosphonate and other known phosphonates, as disclosed, for example, in U.S. Pat. No. 3,159,581, U.S. Pat. No. 3,213,030, U.S. Pat. No. 3,422,021, U.S. Pat. No. 3,400,148 and U.S. Pat. No. 3,422,137.

In addition, the inventive products may comprise volatile alkalizing compounds. These include ammonia and/or C₁₋₉-alkanolamines. Preferred alkanolamines are ethanolamines, particular preference being given to monoethanolamine.

Cleaning products may additionally also comprise organic acids such as acetic acid, glycolic acid, lactic acid, citric acid, succinic acid, adipic acid, malic acid, tartaric acid and gluconic acid, preference being given to acetic acid, citric acid and lactic acid, particular preference to acetic acid. Inventive acidic cleaning product formulations may especially in organic acids, for example mineral acids such as phosphoric acid, sulfuric acid, nitric acid or hydrochloric acid, but also amidosulfonic acid. Additionally suitable are organic acids, preferably short-chain aliphatic mono-, di- and tricarboxylic acids, hydroxycarboxylic acids and dicarboxylic acids. Examples of aliphatic monocarboxylic acids and dicarboxylic acids are C₁-C₆-alkyl and -alkenyl acids, such as glutaric acid, succinic acid, propionic acid, adipic acid, maleic acid, formic acid and acetic acid. Examples of hydroxycarboxylic acids include hydroxyacetic acid and citric acid. It is also possible to use sulfonic acids of the formula R—SO₃H which contain a straight-chain or branched and/or cyclic or unsaturated C₁-C₃₂ hydrocarbon radical R, for example C₆₋₂₂-alkanesulfonic acids, C₆₋₂₂-α-alkanesulfonic acids, C₆₋₂-α-olefinsulfonic acids and C₁₋₂₂-alkyl-C₆₋₁₀-arylsulfonic acids, for example C₁₋₂₂-alkylbenzenesulfonic acids or C₁₋₂₂-alkylnaphthalenesulfonic acids, preferably linear C₈₋₁₆-alkylbenzenesulfonic acids. Particular preference is given to citric acid, acetic acid, formic acid and amidosulfonic acid.

In principle, useful organic solvents are all mono- or polyhydric alcohols. Preference is given to using alcohols having 1 to 4 carbon atoms, such as methanol, ethanol, propanol, isopropanol, straight-chain and branched butanol, glycerol and mixtures of the alcohols mentioned. Further preferred alcohols are polyethylene glycols having a relative molecular mass below 2000. Preference is given especially to use of polyethylene glycol having a relative molecular mass between 200 and 600 and in amounts up to 45% by weight, and of polyethylene glycol having a relative molecular mass between 400 and 600 in amounts of 5 to 25% by weight. An advantageous mixture of solvents consists of monomeric alcohol, for example ethanol, and polyethylene glycol in a ratio of 0.5:1 to 1.2:1.

Further suitable solvents are, for example, triacetin (glyceryl triacetate) and 1-methoxy-2-propanol.

The thickeners used are preferably hydrogenated castor oil, salts of long-chain fatty acids, which are used preferably in amounts of 0 to 5% by weight and especially in amounts of 0.5 to 2% by weight, for example sodium stearate, potassium stearate, aluminum stearate, magnesium stearate and titanium stearate, or the sodium and/or potassium salts of behenic acid, and also polysaccharides, especially xanthan gum, guar-guar, agar-agar, alginates and tyloses, carboxymethylcellulose and hydroxyethylcellulose, and also relatively high molecular weight poly-ethylene glycol mono- and diesters of fatty acids, polyacrylates, polyvinyl alcohol and polyvinylpyrrolidone, and also electrolytes such as sodium chloride and ammonium chloride.

Suitable thickeners are water-soluble polyacrylates which are crosslinked, for example, with about 1% of a polyallyl ether of sucrose and which have a relative molecular mass of above one million. Examples thereof are the polymers obtainable under the name Carbopol® 940 and 941. The crosslinked polyacrylates are used in amounts of not more than 1% by weight, preferably in amounts of 0.2 to 0.7% by weight.

The enzymes optionally present in the inventive products include proteases, amylases, pullulanases, cellulases, cutinases and/or lipases, for example proteases such as BLAP®, Optimase®, Opticlean®, Maxacal®, Maxapem®, Durazym®, Purafect® OxP, Esperase® and/or Savinase®, amylases such as Termamy®, Amylase-LT, Maxamyl®, Duramyl®, Purafectel OxAm, cellulases such as Celluzyme®, Carezyme®, K-AC® and/or the cellulases and/or lipases disclosed by the international patent applications WO 96/34108 and WO 96/34092, such as Lipolase®, Lipomax®, Lumafast® and/or Lipozym®. The enzymes used may, as described, for example, in the international patent applications WO 92/111347 or WO 94/23005, be adsorbed on carriers and/or embedded in coating substances in order to protect them from premature inactivation. They are present in the inventive washing and cleaning products preferably in amounts of up to 10% by weight, especially of 0.05 to 5% by weight, particular preference being given to the use of enzymes stabilized against oxidative degradation.

Inventive machine dishwasher detergents preferably comprise the customary alkali carriers, for example alkali metal silicates, alkali metal carbonates and/or alkali metal hydrogencarbonates. The customarily used alkali carriers include carbonates, hydrogencarbonates and alkali metal silicates having a molar SiO₂/M₂O ratio (M=alkali metal atom) of 1:1 to 2.5:1. Alkali metal silicates may be present in amounts of up to 40% by weight, especially 3 to 30% by weight, based on the overall product. The alkali carrier system used with preference in the inventive cleaning products is a mixture of carbonate and hydrogencarbonate, preferably sodium carbonate and hydrogencarbonate which may be present in an amount of up to 50% by weight, preferably 5 to 40% by weight.

In a further embodiment of inventive products for the automatic washing of dishware, 20 to 60% by weight of water-soluble organic builders, especially alkali metal citrate, 3 to 20% by weight of alkali metal carbonate and 3 to 40% by weight of alkali metal disilicate are present.

In order to bring about silver corrosion protection, it is possible to use silver corrosion inhibitors in inventive cleaning products for dishware. Preferred silver anticorrosives are organic sulfides such as cystine and cysteine, di- or trihydric phenols, optionally alkyl- or aryl-substituted triazoles such as benzotriazole, isocyanuric acid, salts and/or complexes of titanium, zirconium, hafnium, molybdenum, vanadium or cerium.

When the products foam too vigorously on use, it is possible also to add to them up to 6% by weight, preferably about 0.5 to 4% by weight, of a foam-regulating compound, preferably from the group comprising silicones, paraffins, paraffin-alcohol combinations, hydrophobized silicas, fatty acid bisamides and mixtures thereof, and other known commercially available foam inhibitors. The foam inhibitors, especially silicone- and/or paraffin-containing foam inhibitors, are preferably bound to a granular carrier substance soluble or dispersible in water. Special preference is given to mixtures of paraffins and bistearylethylenediamide. Further optional ingredients in the inventive products are, for example, perfume oils.

Useful salts or standardizers include, for example, sodium sulfate, sodium carbonate or sodium silicate (waterglass).

To set a desired pH which does not arise automatically through the mixing of the remaining components, the inventive products may comprise system- and environment-compatible acids, especially citric acid, acetic acid, tartaric acid, malic acid, lactic acid, glycolic acid, succinic acid, glutaric acid and/or adipic acid, but also mineral acids, especially sulfuric acid or alkali metal hydrogensulfates, or bases, especially ammonium or alkali metal hydroxides. Such pH regulators are present in the inventive products preferably to the extent of not more than 10% by weight, especially of 0.5 to 6% by weight.

The inventive products are preferably in the form of pulverulent, granular or tableted preparations and other shaped bodies which can be produced in a known manner, for example by mixing, granulating, roll-compacting and/or by spray-drying the thermally stressable components, and mixing in the more sensitive components, which include especially enzymes, bleaches and the bleach catalyst.

For the production of particulate products with increased bulk density, especially in the range from 650 g/l to 950 g/l, preference is given to a process which has an extrusion step and is disclosed by the European Patent EP 0 486 592. A further preferred production method with the aid of a granulation process is described in the European Patent EP 0 642 576. Inventive products in the form of nondusting, storage-stable free-flowing powders and/or granules having high bulk densities in the range from 800 to 1000 g/l can also be produced by mixing, in a first process stage, the builder components with at least a portion of liquid mixture components while increasing the bulk density of this premixture, and subsequently, if desired after an intermediate drying, combining the further constituents of the product, including the cationic, nitrilic activator, with the premixture thus obtained.

To produce inventive products in tablet form, the procedure is preferably to mix all constituents with one another in a mixer and to compress the mixture by means of conventional tablet presses, for example eccentric presses or rotary presses. In this way, tablets which are fracture-resistant and nevertheless sufficiently rapidly soluble under use conditions and have flexural strengths of normally above 150 N are obtained without any problem. A tablet produced in this way preferably has a weight of 1.5 g to 40 g, especially of 20 g to 30 g, at a diameter of 3-5 mm to 40 mm.

A further preferred embodiment comprises formulations in piece form, which can be used for improving odor and cleaning in toilet bowls (so-called toilet blocks), comprising, in addition to the inventive alkaline earth metal salts of secondary paraffinsulfonic acids, a further 15 to 30% by weight of anionic and/or nonionic surfactants, preferably fatty alkyl sulfates, alkylbenzenesulfonates, alkylpolyglucosides, fatty alkyl ether sulfates, fatty alkyl ethoxylates, 10 to 40% by weight of organic solvent, 5 to 15% by weight of one or more acids or salts thereof, for example formic acid, acetic acid, amidosulfonic acid, sodium hydrogensulfate, coconut fatty acids, 0 to 5% by weight of complexing agents, for example sodium citrate or sodium phosphonate, 0 to 60% by weight of builders, for example sodium sulfate, and 0 to 5% by weight of dyes, fragrances and disinfectants, and also water.

A further preferred embodiment comprises pulverulent formulations which can be used for cleaning toilets (known as toilet cleaning powders), comprising, in addition to the inventive alkaline earth metal salts of secondary paraffinsulfonic acids, a further 15 to 30% by weight of anionic and/or nonionic surfactants, preferably fatty alkyl sulfates, fatty alkyl ethoxylates, alkylbenzenesulfonates, alkylpolyglucosides, fatty alkyl ether sulfates, 10 to 50% by weight of acid, preferably formic acid, acetic acid, citric acid, amidosulfonic acid, potassium or sodium hydrogensulfate, 0 to 5% by weight of complexing agent, 0 to 10% by weight of assistants and fillers, preferably sodium carbonate, 0 to 5% by weight of dyes, fragrances and disinfectants, and also water.

A further preferred embodiment comprises cleaning product pieces in block or tablet form, which can be used for cleaning and rinsing of solid surfaces, for example dishware, floors, windows, or else of textiles, comprising, in addition to the inventive alkaline earth metal salts of secondary paraffinsulfonic acids, a further 0 to 25% by weight of anionic and/or nonionic surfactants, preferably fatty alkyl sulfates, alkylbenzenesulfonates, alkylpolyglucosides, fatty alkyl ether sulfates, betaines, amine oxides, alpha-olefinsulfonates, 10 to 40% by weight of organic solvent, 0 to 5% by weight of dyes, fragrances and disinfectants, and also water.

In addition to the ingredients already mentioned, the washing and cleaning products may comprise any of the conventional additives in amounts typically found in such products.

The examples which follow are intended to illustrate the subject matter of the invention in detail, without restricting it thereto.

### EXAMPLES

### Procedure

The surfactant combinations in this invention are prepared by simple mixing of the constituents in a suitable vessel. The mixtures of this invention were studied for their cleaning action on standardized stains.

### Wash Tests

The wash tests were carried out in standardized washing apparatus (Linitest, 40° C., 15° dH, 30 min, pH=10-10.5) with standardized stains, and the washing action was determined by the measurement of the change (before/after) in reflectance with a spectrophotometer (Elrepho 3000) at 457 nm.

### Example 1

| Surfactant | Exp. 1 % | Exp. 2 % | Exp. 3 % | Exp. 4 % | Exp. 5 % |
|---|---|---|---|---|---|
| SAS | 100 | 75 | 50 | 25 | 0 |
| φ-MES | 0 | 25 | 50 | 75 | 100 |
| ΔR | 11.0 | 11.4 | 10.0 | 5.9 | 4.0 |

### Example 2

| Surfactant | Exp. 6 % | Exp. 7 % | Exp. 8 % | Exp. 9 % | Exp. 10 % |
|---|---|---|---|---|---|
| SAS | 100 | 75 | 50 | 25 | 0 |
| α-MES | 0 | 25 | 50 | 75 | 100 |
| ΔR | 9.3 | 9.2 | 11.0 | 11.9 | 11.9 |

### Example 3

| Surfactant | Exp. 11 % | Exp. 12 % | Exp. 13 % | Exp. 14 % | Exp. 15 % |
|---|---|---|---|---|---|
| α-MES | 100 | 75 | 50 | 25 | 0 |
| φ-MES | 0 | 25 | 50 | 75 | 100 |
| ΔR | 11.4 | 10.8 | 9.2 | 6.7 | 4.0 |

### Result of the Wash Tests:

Water (15° dH) without addition of surfactant was used as a reference, and a total surfactant concentration of 0.4% was used. The 30-minute washing operation was followed by washing three times with tap water and once with deionized water, spinning and ironing. The reflectance values were measured after cooling and subtracted from the values measured beforehand. The graphic plot of the values thus measured (see figures) clearly shows the synergistic effect of the surfactant mixtures compared to the individual components.

The appended drawing illustrates the synergistic effect of the inventive surfactant combinations. This synergistic effect is demonstrated by a greater than proportional increase in whiteness.

1. A surfactant mixture consisting of two or three surfactants selected from the group consisting of sec-alkanesulfonates, α-methyl ester sulfonates and φ-methyl ester sulfonates.

2. The surfactant mixture as claimed in claim 1, consisting of two surfactants in a ratio of 99:1 to 1:99.

3. The surfactant mixture as claimed in claim 1, consisting of sec-alkylsulfonate and φ-methyl ester sulfonate in a ratio of 90:10 to 60:40.

4. The surfactant mixture as claimed in claim 1, consisting of sec-alkylsulfonate and α-methyl ester sulfonate in a ratio of 50:50 to 10:90.

5. The surfactant mixture as claimed in claim 1, consisting of α-methyl ester sulfonate and φ-methyl ester sulfonate in a ratio of 90:10 to 30:70.

6. A washing or cleaning product comprising a surfactant mixture as claimed in claim 1.
